(19) United States
(12) Patent Application Publication
(10) Pub. No.: US 2006/0216453 A1
(43) Pub. Date: Sep. 28, 2006

(54) Durable pigmented film

(75) Inventor: Ronald N. Hubbard, Encinitas, CA (US)

Correspondence Address: GREER, BURNS & CRAIN, 300 S WACKER DR, 25TH FLOOR, CHICAGO, IL, 60606, US

(73) Assignee: General Atomics

(21) Appl. No.: 11/087,964

(22) Filed: Mar. 23, 2005

(51) Int. Cl. B32B 33/00; B29C 39/14; B29D 7/01

(52) U.S. Cl. 428/41.6; 428/220; 428/343; 264/216

(57) ABSTRACT

A durable pigmented film, particularly intended for use in lieu of or as a replacement for conventional paint, is a composite film having a thickness of from about 1 to about 20 microns and comprised of a polymer matrix containing from about 15 to about 50% by volume of pigment particles. Methods of making and using the film are disclosed.

### FIELD OF THE INVENTION

The present inventions relates to pigmented films, particularly films intended to be used in lieu of or as replacements for conventional paint, and to methods for producing and using the pigmented films.

### BACKGROUND OF THE INVENTION

Paints, for example military paints, are formulated with a variety of colored pigments to match specific standard colors so that when painting or touch-up is required, a good color match can be obtained. A major problem with paints is that there are limited locations where painting is allowed due to environmental restrictions.

Paint replacement films adapted to be adhesively adhered to surfaces to be painted or repainted have been developed to alleviate environmental concerns. Thin multilayer vacuum deposited coatings are applied to the films to provide the desired spectral properties. However, it is difficult with these films to match the color and gloss of paints. Also, the exposed coatings suffer durability problems.

Additionally, for some applications, such as antennas and radomes, the dielectric constant and thickness of the prior coating materials, whether paint or film, precludes their use because of interference with the radio frequency (RF) properties of the structure.

### SUMMARY OF THE INVENTION

In accordance with the present invention, extremely thin, flexible pigmented polymer films are produced by application of a pigment loaded liquid polymer to a substrate followed by curing of the polymer and removal of the resulting thin film from the substrate. In particular, using a liquid roll coater followed by ultraviolet (UV) curing, various polymers, such as acrylates and polyurethanes, can be formed at thicknesses of as little as 1 to 20 microns. In accordance with the invention, thin film pigments, such as those disclosed in U.S. Pat. Nos. 5,506,053 and 5,814,367, are dispersed in the polymer thereby to produce UV cured pigmented paint replacement films having a thickness of only 1 to 20 microns.

The cured polymer protects the thin film pigments, which solves durability issues associated with multilayer vacuum deposited coatings being directly exposed to environmental damage. The very thin pigmented film cures the problem of painting RF sensitive surfaces. The use of mixed pigments solves the color matching problem. And the much thinner polymer layer over the pigment provides increased spectral performance compared to paint or top coat films. Also, since the pigmented polymer is deposited and cured in a controlled environment where all VOC's are captured, environmental problems are alleviated.

The invention thus provides RF compatible pigmented films with high physical and spectral performance and excellent color matching to existing color standards.

These and other objects and advantages of the invention will become apparent to those of reasonable skill in the art from the following detailed description as considered in conjunction with the accompanying drawings.

### BRIEF DESCRIPTION OF THE DRAWINGS

FIG. 1 is a schematic illustration of a system for forming a thin pigmented film on a substrate; and

FIG. 2 is a schematic illustration of a system for forming a thin pigmented film on an adhesive coated release sheet substrate to provide an adhesive coated pigmented film ready for application to a surface to be painted or repainted.

### DETAILED DESCRIPTION OF PREFERRED EMBODIMENTS

The following is a detailed description of certain embodiments of the invention presently contemplated by the inventor to be the best mode of carrying out his invention.

The product of the invention is a thin, flexible polymer film, preferably having a thickness of from about 1 to about 20 microns, and containing from about 15% to about 50% by volume of pigment particles.

The polymer may be an acrylate, a polyurethane or any other polymer that can be deposited to the thickness specified and cured into a solid flexible film. Flexibility is a desired characteristic as the film will in use be required to conform to a variety of surfaces, shapes and forms, e.g., military vehicles, water and air craft, ground installations, etc. An acrylate is preferred as it is relatively easy to deposit in a thin film and to cure with UV exposure.

The thin film pigment particles are of micro size consistent with the thickness of the film, i.e., they are of a size smaller than the film thickness. The particles may be of any suitable shape, composition and coloration, as required for performance characteristics and color matching. For RF sensitive surfaces, the particles and film are preferably radio frequency transparent or substantially so. The pigment particles may be flat, spherical (e.g., micro spheres and micro balloons) or geometric and are preferably selected from the pigment particles disclosed in U.S. Pat. Nos. 5,506,053, 5,814,367, 6,033,782, 6,235,105 and 6,288,837, all of which patents are owned by the Assignee of the present invention, and all of which are incorporated herein by reference.

The product of the invention is made by dispersing pigment particles uniformly throughout a liquid polymer matrix at a volume ratio of from about 15% to about 50%. The pigment loaded liquid polymer is then deposited to a selected thickness onto a substrate to form a liquid film which is then cured to set the polymer into a solid flexible film. The substrate preferably comprises a continuous web of a flexible polymer having good release characteristics so that the thin film can be easily stripped from the substrate. Suitable substrate materials include: polyurethane, polytetraflouroethylene, polyethyleneterephthalate, etc.

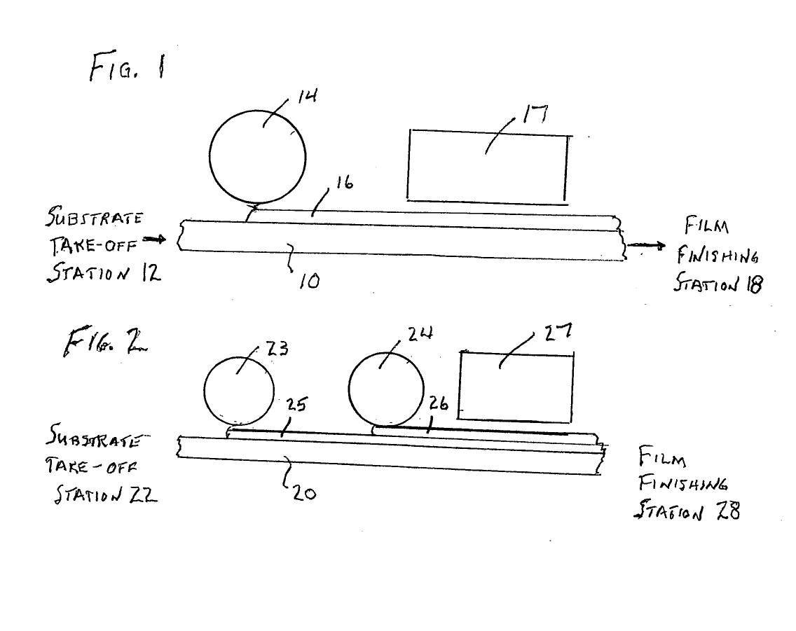

As illustrated schematically in FIG. 1, the products of the invention may be made by moving a web 10 of substrate material from a web take-off or unwind station 12 through a coating station 14 where a thin film 16 of the pigment loaded liquid polymer is deposited on the substrate, through a curing station 17 where the polymer is cured and to take-up or finishing station 18. The coating station 14 and the curing station 17 may comprise any of a number of conventional coating and curing apparatus available on the market. However, a liquid roll coater and a UV curing device have been found to be efficient and effective.

At the finishing station 18, the substrate 10 and film 16 are wound into rolls or otherwise prepared for further processing. The substrate 10 and the pigmented film 16 may, for example, be wound together into a roll for protection of the pigmented film during shipping and handling, in which case the thin film is stripped from the substrate at a point of use. Alternatively, the pigmented film may be stripped from the substrate at the point of manufacturer and wound into rolls or cut into sheets or cut into pre-selected patterns intended for particular applications e.g., radome covers. At the point of use, an adhesive is applied to the article to be painted and/or to an appropriately shaped piece of pigmented film and the piece of film is then adhered to the surface of the article so as to “paint” the article to a specified color standard. The pigmented film may be used for touch-up work or for complete paint jobs, as needed.

In lieu of requiring application of an adhesive to an article at a point of use, the pigmented film may be pre-coated with an adhesive at its point of manufacture. As illustrated schematically in FIG. 2, a web 20 of substrate material may be taken from a take-off or unwind station 22 and moved sequentially through an adhesive application station 23 where a layer of adhesive is applied to the substrate, a liquid coating application station 24 where a thin liquid film of pigmented polymer 26 is deposited on the layer 25 of adhesive, a curing station 27 where the polymer is cured and a take-up or finishing station 28. As with FIG. 1, the apparatus employed in the system of FIG. 2 may be of any conventional type, with roll coating and UV curing being preferred.

In the case of the adhesive coated film 26 of FIG. 2, the substrate 20 remains associated with the adhesive 25 and pigmented film 26 up to the point of use to protect the adhesive and to serve as a release sheet for the adhesive. At the point of use, the release sheet substrate 20 is stripped from the adhesive 25 and the film 26 is adhesively adhered to the surface of the article to be painted.

As above described for the pigmented film 16 of FIG. 1, the adhesively pre-coated film 26 of FIG. 2 may be delivered to a worksite in rolls, sheets or precut patterns and may be used for touch-up work and complete paint jobs, as needed.

In the finished product, the polymer enrobes and protects the pigment particles; the thinness of the polymer layer over the particles enhances the spectral performance of the particles; the thinness of the film renders the film compatible with RF sensitive surfaces; the thinness and flexibility of the film facilitates application to a myriad of objects and surface shapes, forms and configurations; and the use of mixed pigments facilitates matching to color standards.

The invention thus provides RF compatible pigmented films with high physical and spectral performance and excellent color matching to existing color standards.

The objects and advantages of the invention have therefore been shown to be attained in a convenient, economical, practical and facile manner.

While preferred embodiments of the invention have been herein illustrated and described, it is to be appreciated that various changes, rearrangements and modifications may be made therein without departing from the scope of the invention as defined by the appended claims.

What is claimed is:

1. A durable pigmented film comprising a polymer film having a thickness from about 1 to about 20 microns and containing from about 15 to about 50% by volume of pigment particles.

2. A film as set forth in claim 1 wherein the polymer comprises an acrylate or a polyurethane.

3. A film as set forth in claim 1 wherein the pigment particles are flat, spherical and/or of geometric shape.

4. A film as set forth in claim 1 wherein the film is substantially transparent to radio frequencies.

5. A film as set forth in claim 1 including a layer of adhesive on the film for adhering the film to an article.

6. A film as set forth in claim 1 wherein the pigmented film is to be adhered to an article in lieu of or as a replacement for conventional paint.

7. A film as set forth in claim 1 wherein the film is substantially radio frequency transparent and is to be adhered to a radio frequency sensitive surface in lieu of or as a replacement for conventional paint.

8. A durable pigmented film for use in lieu of or as a replacement for conventional paint comprising a composite film having a thickness of from about 1 to about 20 microns and comprised of pigment particles dispersed in a polymer matrix at a concentration of from about 15% to about 50% by volume.

9. A film as set forth in claim 8 wherein the polymer comprises an acrylate or a polyurethane.

10. A film as set forth in claim 8 wherein the pigment particles are flat, spherical and/or of geometric shape.

11. A film as set forth in claim 8 wherein the film is substantially transparent to radio frequencies.

12. A film as set forth in claim 8 including a layer of adhesive on the film for adhering the film to an article.

13. A film as set forth in claim 12 including a release sheet protectively covering the adhesive.

14. A method of making a durable pigmented film comprising the steps of dispersing micro size pigment particles throughout a liquid polymer matrix at a ratio of from about 15 to about 50% by volume, applying the liquid pigmented polymer to a substrate at a thickness from about 1 to about 20 microns, curing the polymer to form a solid flexible film, and subsequently stripping the film from the substrate.

15. A method as set forth in claim 14 including the step of using the film in lieu of or as a replacement for conventional paint.

16. A method as set forth in claim 14 including the step of stripping the film from the substrate at the point of manufacture.

17. A method as set forth in claim 14 including the step of stripping the film from the substrate at a point of use.

18. A method as set forth in claim 14 including the step of first applying a layer of adhesive to the substrate and then applying the liquid pigmented polymer onto the layer of adhesive.

19. A method as set forth in claim 18 including the step of stripping the substrate from the adhesive and the pigmented film at a point of use.
